(19) United States
(12) Patent Application Publication
(10) Pub. No.: US 2003/0053123 A1
(43) Pub. Date: Mar. 20, 2003

(54) Method of communicating with a printing system using a rule-based protocol

(76) Inventors: Michael Wu, Fairport, NY (US); Steve Maier, Farmington, NY (US)

Correspondence Address: Richard A. Romanchik, Heidelberg Digital L.L.C., 2600 Manitou Road, Rochester, NY, 14624, US

(21) Appl. No.: 10/229,172

(22) Filed: Aug. 26, 2002

Related U.S. Application Data
(60) Provisional application No. 60/317,672, filed on Sep. 5, 2001.

(51) Int. Cl. B41J 1/00; G06F 15/00

(52) U.S. Cl. 358/1.15

(57) ABSTRACT

A method of communicating with a printing system over a communications network using a rule-based protocol. The method includes building a rule-based protocol request message on a remote processing system. The rule-based protocol request message includes an operator name. The remote processing system transmits the rule-based protocol request message from remote processing system to the printing system over the communications network. The remote processing system determines whether the remote processing system receives a rule-based protocol response message from the printing system. When the remote processing system receives the rule-based protocol response message from the printing system, the remote processing system reads an attribute name associated with the operator name. The rule-based protocol response message includes the attribute name.

### FIELD OF THE INVENTION

This invention relates to digital printing. More particularly the invention relates to a method of communicating with a printing system using a rule-based protocol.

### BACKGROUND

A digital printing system may provide for remote operation of the printing system from a remote processing system. Running a print job on the printing system or configuring the printing system remotely requires that the remote operating system communicate with the printing system. Typically, the remote processing system loads printer driver software into memory to provide the communication to the printer system.

A printer driver provides information on the printing system to the remote processing system. The information may include job status, available finishing devices, paper catalog list, or job capacity on the printing system. If the remote processing system communicates with the printing system through a network, a communication protocol provides for the exchange of the information.

One such protocol for communicating between the remote processing system and the printing system is the Internet Printing Protocol (“IPP”). IPP is described in the Internet Engineering Task Force (“IETF”) standard Request For Comments (“RFC”) 2567 titled “Design Goals for an Internet Printing Protocol,” dated April 1999. As is known to those of ordinary skill in the art IPP messages may penetrate firewalls. A firewall is a security feature that limits the transfer of harmful communications between a group of network devices on a Local Area Network (“LAN”) and the Internet. Although remote processing devices that share the same LAN as the printing system may communicate with the printing system, a remote processing system that attempts to communicates with the printing system through the Internet may have its messages blocked by one or more firewalls.

IPP messages penetrate firewalls because IPP binds to the Hypertext Transfer Protocol (“HTTP”). IPP messages, however, only have a fixed, pre-defined set of operations and attributes that may be communicated between network devices over the Internet. Modern printing systems are very flexible in the number and type of attributes that may be communicated, and the printer driver on the remote processing system may require a flexible set of operations beyond those provided by IPP. Therefore, there is a need to provide a method of communication between a remote processing system and a printing system that is flexible in its vocabulary of operations and attributes.

### SUMMARY OF THE INVENTION

In accordance with the invention, a method of communicating with a printing system over a communications network using a rule-based protocol includes building a rule-based protocol request message on a remote processing system. The rule-based protocol request message includes an operator name. The remote processing system transmits the rule-based protocol request message from remote processing system to the printing system over the communications network. The remote processing system determines whether the remote processing system receives a rule-based protocol response message from the printing system. When the remote processing system receives the rule-based protocol response message from the printing system, the remote processing system reads an attribute name associated with the operator name. The rule-based protocol response message includes the attribute name.

### BRIEF DESCRIPTION OF THE DRAWINGS

FIG. 1 is a block diagram of document production system in accordance with the invention.

FIG. 2 is a block diagram illustrating a preferred protocol stack for the printing system and the remote processing system in accordance with the invention.

FIG. 3 is a flow diagram illustrating a preferred method for communicating with a printing system over a communications network using a rule-based protocol in accordance with the invention.

### DETAILED DESCRIPTION OF THE INVENTION

As used herein, a printing system shall refer to a digital printing system, a duplicating system, or both. This invention relates to a printing system that has at least one input source and preferably multiple input sources and at least one output destination. Further, where multiple input sources are present, each of the input sources may be loaded with different media (e.g., different types or sizes of paper). The printing system 26 may be capable of producing collated output sets of sheets, which are deposited in one or more of the output destinations.

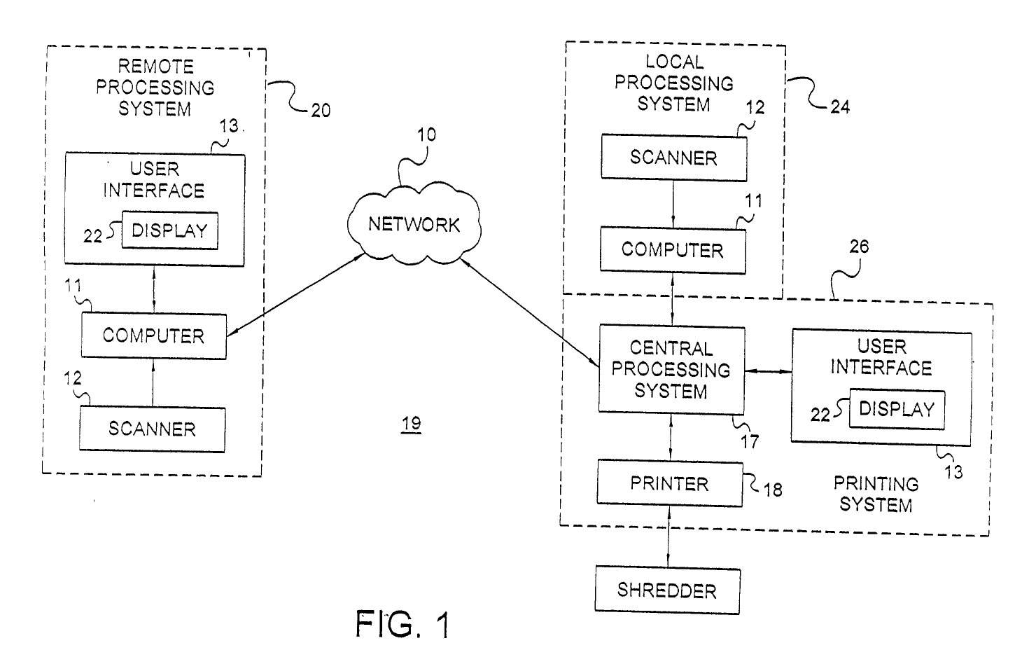

In accordance with the invention, FIG. 1 shows a block diagram of a 5 document production system 19. The document production system 19 includes a remote processing system 20, a communications network 10, a local processing system 24, and a printing system 26. The remote processing system 20 may communicate with the printing system 26 over the communications network 16. The local processing system 24 may communicate directly with the printing system 26.

The document production system 19 facilitates the conversion of a physical representation (e.g., printed page) of an input image to an electronic representation at the local processing system 24 or at the remote processing system 20. The document production system 19 facilitates the transfer of an electronic representation of one or more input images from a remote processing system 20 to the printing system 26 over the communications network 16. The printing system 26 processes the electronic representation in a manner that supports page-by-page routing of output pages to one or more output destinations of the printer 18.

The remote processing system 20 includes a user interface 13 coupled to a computer 11. In turn, the computer 11 is coupled to a scanner 12. In one embodiment, the user interface 13 refers to a graphical user interface that includes a keyboard, a pointing device (e.g., mouse), a display 22, and attendant software instructions to support the keyboard, the pointing device, and the display 22. The computer 11 may represent a source or receptor of one or more print jobs for the printing system 26. For example, the computer 11 may support a print job derived from the operation of the scanner 12. The computer 11 may transmit the print jobs, including electronic representations of input images or documents, to the printing system 26 via the communications network 10. The communications network 10 may refer to the Internet, an intranet, a circuit-switched network, a data packet network, an Ethernet system, or any other suitable communications network.

The local processing system 24 includes a scanner 12 coupled to a computer 11. In turn, the computer 11 manages communications with a central processing unit (“CPU”) 17 of the printing system 26. The local processing system 24 may represent a source or receptor of one or more print jobs to the printing system 26.

The remote processing system 20 or the local processing system 24 can create electronic representations of input pages for execution by the printing system 26. The scanner 12 supports scanning of input images on pages and producing an electronic representation of the input images for printing on the printing system 26.

The printing system 26 includes a CPU 17 that is coupled to a user interface 13 and a printer 18. The user interface 13 includes a display 22. The CPU 17 refers to a computer or data processing system, which accepts print jobs via the communications network 16 or otherwise. For example, the print jobs may come from the remote processing system 20, the local processing system 24, or both.

The CPU 17 controls many or all aspects of printing one or more print jobs on the printer 18. The CPU 17 may be physically implemented using one or more data processors, in a conventional or parallel computing architecture to control the printing process. The CPU 17 may determine a pattern of media feeds for each output set of a print job to achieve a desired appearance characteristic of sheets of an output set. The desired appearance characteristic may include scaling of an image, resolution of an image, contrast of an image, darkness or intensity of an image, the order of sheets in an output set, the selection of media for different sheets in an output set, stapling of sheets in an output set, binding of an output set, holes in media of the output set, or other attributes that affect the visual appearance or presentation of a print job.

The printing system 26 may maintain data bits at memory locations in its respective memory systems to reconfigure or otherwise alter the CPU's 17 operation, as well as other processing of signals. The memory locations, such as random access memory (“RAM”), are physical locations that have particular electrical, magnetic, or optical properties corresponding to the data bits, depending on the type of memory used. The local processing system 24 and remote processing system 20 also include respective central processing units (not shown) in their computers 11, and also include respective memory systems (not shown).

The data bits may also be maintained on a computer readable medium including magnetic disks, optical disks, and any other volatile or non-volatile mass storage system readable by the CPU 17 of the printing system 26 or by the computers 11 within the local processing system 24 and remote processing system 20. The computer readable medium includes cooperating or interconnected computer readable media that exist exclusively on the printing system 26 or are distributed among multiple interconnected processing systems such as the local processing system 24 or the remote processing system 20.

The user interface 13 supports a user's selection of features of the printing system 26 or preferences in the ultimate presentation of the output set or print job produced by the printing system 26. Upon receiving a print job at the CPU 17, a user of the printing system 26 uses the user interface 13 to check the status of the print job or jobs. Further, the user may use the user interface 13 to determine how the print jobs are set up. The display 22 of the user interface 13 may have separate screens dedicated to corresponding functions such as displaying the status of the print job and structuring the setup of the print jobs. A screen represents an image that is displayed on the display 22 of the user interface 13.

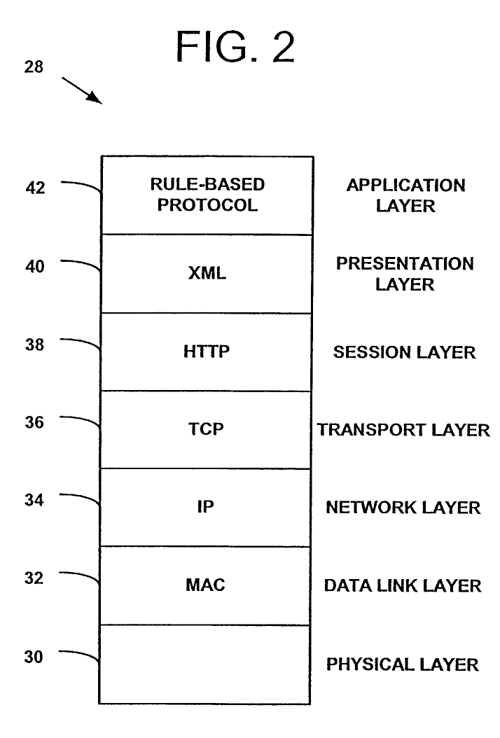

An additional screen allows the operator to view the attributes of the media loaded in the input sources, which are shown in FIG. 2. Another additional screen provides the display of jam recovery instructions so that the user is notified of jam recovery instructions or instantaneous feedback on corrective measures that the user has applied to the printer 18.

A printer driver is software that is loaded into memory by an operating system when a user selects print from an application. A user at the printing system 26 may select print from the user interface 13. The operating system running on the CPU 17 loads the printer driver software into the printer system 26 memory and presents the user with an interface 13 to the printer driver. Alternatively, another user at the remote processing system 20 may select print from the user interface 13 on the remote processing system 20. In that case, the operating system running on the computer 11 loads the printer driver software into the remote processing system 20 memory and presents the user with an interface 13 to the printer driver.

The printer driver engages in two-way communication with the printing system 26 to provide information on the printing system 26 to the remote processing system 20. The information may include a job status, what finishing devices are attached to the printer 18 and are available for use, a paper catalog list of the media available to the printer 18 or presently loaded in the paper sources of the printer 18, or job capacity information on how many print jobs are in the queue of the printing system 26.

Printing systems 26 and remote processing systems 20 are increasingly including Internet interfaces and World Wide Web (“WWW”) interfaces for communicating with other network devices over the Internet 10. In a preferred embodiment of the present invention, the printing system 26 and the remote processing system 20 include WWW interfaces for communicating across the Internet 10.

FIG. 2 is a block diagram illustrating a preferred protocol stack 28 for the printing system 26 and the remote processing system 20. As is known to those of ordinary skill in the art, the Open System Interconnection (“OSI”) model may be used to describe computer networks. The OSI model consists of seven layers including, from lowest-to-highest, a physical, data-link, network, transport, session, presentation and application layer.

The physical layer 30 transmits data between network devices as bits over a communication link or transmission medium. The physical layer 30 controls the electrical and mechanical connections of the network device to the physical transmission medium such as Ethernet.

Above the physical layer 30 is the data-link layer 32. As illustrated in FIG.2, a preferred protocol for the data-link layer 32 is a Medium Access Control (“MAC”) protocol. As is known in the art, the MAC protocol controls access to a transmission medium via the physical layer 30. MAC addresses are typically 48-bit addresses that are unique to each MAC interface for network devices. For example, the MAC interface for the printing system 26 will have a unique 48-bit address.

Above the data-link layer 32 is a network layer 34. A preferred protocol for the network layer 34 is an Internet Protocol (“IP”). The IP roughly corresponds to OSI layer 3, the network layer, but is typically not defined as part of the OSI model. As is known to those of ordinary skill in the art, the IP is a routing protocol designed to route traffic within a network or between networks. Additional information on the IP may be found in the Internet Engineering Task Force (“IETF”) standard Request For Comments (“RFC”) 791 titled “Internet Protocol,” dated September 1981.

Above the network layer 34 is the transport layer 36. A preferred protocol for the transport layer 34 is a Transmission Control Protocol (“TCP”). The TCP roughly corresponds to OSI layer 4, the transport layer, but is typically not defined as part of the OSI model. As is known to those of ordinary skill in the art, the TCP provides a connection-oriented mode of communication with datagrams. Additional information on the TCP may be found in IETF standard RFC 793 titled “Transmission Control Protocol,” dated September 1981.

Above the transport layer 36 is the session layer 38. A preferred protocol for the session layer 38 is a Hypertext Transfer Protocol (“HTTP”). HTTP is a protocol for exchanging files on the World Wide Web. Additional information on the HTTP may be found in IETF standard RFC 2068 titled “Hypertext Transfer Protocol,” dated January 1997.

Above the session layer 38 is the presentation layer 40. A preferred protocol for the presentation layer 40 is an eXtensible Markup Language (“XML”). XML is a document markup language for defining structured information. Additional information on the XML may be found in W3C recommendation titled “Extensible Markup Language (XML) 1.0 (Second Edition),” dated October 2000, and is available at URL: http://www.w3.org/TR/REC-xml, which is incorporated herein by reference.

Above the presentation layer 40 is the application layer 42. A preferred protocol for the session layer 38 is a rule-based protocol such as Simple Object Access Protocol (“SOAP”). Rule-based protocols, such as SOAP, permit applications running on one network device, such as the remote processing system 20, to communicate with another application running on another network device, such as the printing system 26. The SOAP uses HTTP and XML to exchange information between applications running on the different network devices over the communications network 10. The two network devices may have different operating systems and may run their respective applications according to the respective operating systems. Additional information on the SOAP may be found in W3C note titled “Simple Object Access Protocol (SOAP) 1.1),” dated May 2000, and is available at URL: http://www.w3.org/TRISOAP, which is incorporated herein by reference.

A rule-based protocol is more flexible than IPP for communication between the remote processing system 20 and the printing system 26 because the information that may be passed using IPP is restricted to a static set of operations and attributes. For example, the pre-defined IPP operation “status code” may be sent as a message from the remote processing system 20 to the printing system 26 within an HTTP message. The printing system 26 receives the message, decapsulates it, and processes the message in the CPU 17. The CPU 17 determines the status of the printer, 18, i.e., whether the printer 18 has one of three attributes idle, busy or jammed. The printing device 26 replies to the remote processing system 20 in a message that returns the status as an attribute in an IPP message. Communication using IPP, however, is restricted to only those operations and those attributes that are supported by IPP.

Rule-based protocols, such as SOAP, provide for user-defined, rather than pre-defined, operations and attributes. In this manner, the user may define transfer information regarding many more features of the printing device 26, which is important because modern digital printing systems 26 are increasing in complexity and flexibility. A flexible set of operations and attributes may provide for increased efficiency and improved remote operation of the printing system 26.

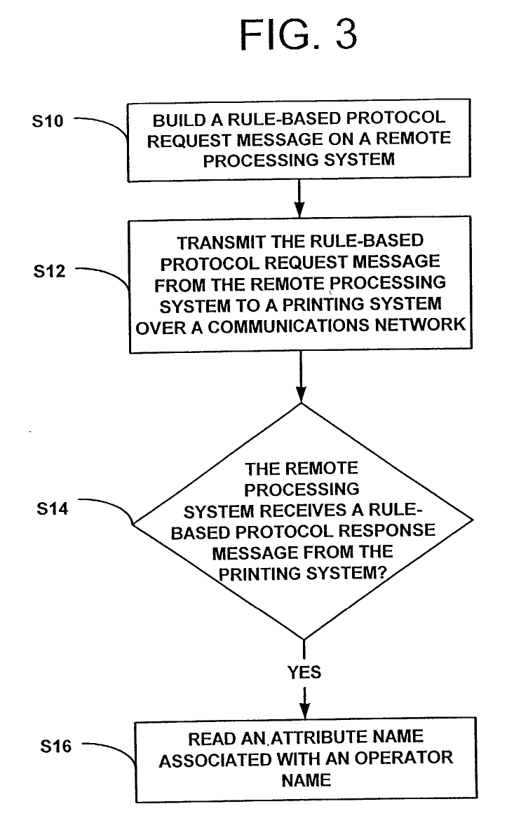

FIG. 3 is a flow diagram illustrating a preferred method of communicating with a printing system 26 over a communications network 10 using a rule-based protocol in accordance with the invention. In step S10, the remote processing system 20 builds a rule-based protocol request message. The rule-based protocol request message includes an operator name.

In step S12, the remote processing system 20 transmits the rule-based protocol request message from the remote processing system 20 to the printing system 26 over the communications network 10.

In step S14, the remote processing system 20 determines whether the remote processing system 20 receives a rule-based protocol response message from the printing system 26.

In step S16, if the remote processing system 20 does receive the rule-based protocol response message from the printing system 26, the remote processing system 20 reads an attribute name associated with the operator name. The rule-based protocol response message includes the attribute name.

In the SOAP protocol, each block within a <SOAP-ENV:Body> and </SOAP-ENV:Body> is a function call with an operator name, as is familiar to those of ordinary skill in the web networking art. For example, a SOAP request message of the form of Expression 1 includes an operator name for the function that asks the printing system 26 what papers are in its paper catalog.

Expression 1.

<?xml version=“1.0” encoding=“UTF-8” ?>
≦SOAP-ENV:Envelope xmlns:xsd=“http://www.w3.org/1999/
XMLSchema”

xmlns:xsi=“http://www.w3.org/1999/XMLSchema-instance”
xmlns:SOAP-ENC=“http://schemas.xmlsoap.org/soap/encoding/”
xmlns:SOAP-ENV=“http://schemas.xmlsoap.org/soap/envelope/”
SOAP-
ENV:encodingStyle=“http://schemas.xmlsoap.org/soap/encoding/”>

≦SOAP-ENV:Body>

≦ns0:getPapers

xmlns:ns0=“http://tempuri.org/papercatgate.PaperCatGate”>
<language xsi:type=“ns1:string”

xmlns:ns1=“http://www.w3.org/1999/XMLSchema”>en</
language>

</ns0:getPapers>

</SOAP-ENV:Body>
</SOAP-ENV:Envelope>

The printing system 26 receives the SOAP message and, in response to the request for the media in its paper catalog, builds a SOAP response message returning the attributes of the media in its paper catalog. Each media has five attributes: name, color, type, weight, and size. The form of the SOAP response message is shown in Expression 2.

Expression 2

<?xml version=“1.0” encoding=“UTF-8” ?>
≦soap:Envelope xmlns:xsi=“http://www.w3.org/1999/XMLSchema-

instance” xmlns:xsd=“http://www.w3.org/1999/XMLSchema”
xmlns:soap=“http://schemas.xmlsoap.org/soap/envelope/”
xmlns:soapenc=“http://schemas.xmlsoap.org/soap/encoding/”
soap:encodingStyle=“http://schemas.xmlsoap.org/soap/encoding/”>

≦soap:Body>

≦n:getPapersResponse

xmlns:n=“http://tempuri.org/papercatgate.PaperCatGate”>
<Result href=“#id0” />

</n:getPapersResponse>
≦id0 id=“id0” soapenc:root=“0”

xmlns:ns2=“http://www.myCompany.com/package/papercatg
ate/” xsi:type=“soapenc:Array”
soapenc:arrayType=“ns2:Paper[21]”>
<i href=“#id1” />
<i href=“#id7” />
<i href=“#id13” />
<!-- an increment of 6 ID's listed here -->
<i href=“#id121” />

<id0>
≦id1 id=“id1” soapenc:root=“0”

xmlns:ns2=“http://www.myCompany.com/package/papercatg
ate/” xsi:type=“ns2:Paper”>
<ID xmlns:ns0=“http://www.w3.org/1999/XMLSchema”

xsi:type=“xsd:int”>0</ID>

<name href=“#id2” />
<color href=“#id3” />
<type href=“#id4” />
<weight href=“#id5” />
<size href=“#id6” />

</id1>
≦id2 id=“id2” soapenc:root=“0”

xmlns:ns2=“http://www.myCompany.com/package/papercatg
ate/” xsi:type=“ns2:PaperStringIdAttribute”>
<ID xmlns:ns0=“http://www.w3.org/1999/XMLSchema”

xsi:type=“xsd:int”>−2</ID>

<stringID

xmlns:ns0=“http://www.w3.org/1999/XMLSchema”
xsi:type=“xsd:int”>206</stringID>

<displayString

xmlns:ns0“http://www.w3.org/1999/XMLSchema”
xsi:type=“xsd:string”>Letter</displayString>

<isWildcard

xmlns:ns0“http://www.w3.org/1999/XMLSchema”
xsi:type=“xsd:boolean”>false</isWildcard>

<isObsolete

xmlns:ns0=“http://www.w3.org/1999/XMLSchema”
xsi:type=“xsd:boolean”>false</isObsolete>

</id2>
≦id3 id=“id3” soapenc:root“0”

xmlns:ns2“http://www.myCompany.com/package/papercatg
ate/” xsi:type=“ns2:PaperStringIdAttribute”>
<ID xmlns:ns0=“http://www.w3.org/1999/XMLSchema”

xsi:type=“xsd:int”>1</ID>

<stringID

xmlns:ns0=“http://www.w3.org/1999/XMLSchema”
xsi:type“xsd:int”>310</stringID>

<displayString

xmlns:ns0=“http://www.w3.org/1999/XMLSchema”
xsi:type=“xsd:string”>white</displayString>

<isWildcard

xmlns:ns0“http://www.w3.org/1999/XMLSchema”
xsi.type=“xsd:boolean”>false</isWildcard>

<isObsolete

xmlns:ns0=“http://www.w3.org/1999/XMLSchema”
xsi:type=“xsd:boolean”>false</isObsolete>

</id3>
≦id4 id=“id4” soapenc:root=“0”

xmlns:ns2=“http://www.myCompany.com/package/papercatg
ate/” xsi:type=“ns2:PaperStringIdAttribute”>
<ID xmlns:ns0=“http://www.w3.org/1999/XMLSchema”

xsi:type=“xsd:int”>1</ID>

<stringID

xmlns:ns0=“http://www.w3.org/1999/XMLSchema”
xsi:type=“xsd:int”>319</stringID>

<displayString

xmlns:ns0=“http://www.w3.org/1999/XMLSchema”
xsi:type=“xsd:string”>plain</displayString>

<is Wildcard

xmlns:ns0=“http://www.w3.org/1999/XMLSchema”
xsi:type=“xsd:boolean”>false</isWildcard>

<isObsolete
xmlns:ns0=“http://www.w3.org/1999/XMLSchema”
xsi:type=“xsd:boolean”>false</isObsolete>

</id4>
≦id5 id=“id5” soapenc:root=“0”

xmlns:ns2=“http://www.myCompany.com/package/papercatg
ate/” xsi:type=“ns2:PaperWeightAttribute”>
<ID xmlns:ns0=“http://www.w3.org/1999/XMLSchema”

xsi:type=“xsd:int”>75</ID>

<weight xmlns:ns0=“http://www.w3.org/1999/XMLSchema”

xsi:type=“xsd:int”>75<weight>

<isWildcard

xmlns:ns0=“http://www.w3.org/1999/XMLSchema”
xsi:type=“xsd:boolean”>false</isWildcard>

<isObsolete

xmlns:ns0=“http://www.w3.org/1999/XMLSchema”
xsi:type=“xsd:boolean”>false</isObsolete>

<displayString
xmlns:ns0=“http://www.w3.org/1999/XMLSchema”
xsi:type=“xsd:string”>75</displayString>

</id5>
≦id6 id=“id6” soapenc:root=“0”

xmlns:ns2=“http://www.myCompany.com/package/papercatg
ate/” xsi:type=“ns2:PaperSizeAttribute”>
<ID xmlns:ns0=“http://www.w3.org/1999/XMLSchema”

xsi:type=“xsd:int”>1</ID>

<width_tmm

xmlns:ns0=“http://www.w3.org/1999/XMLSchema”
xsi:type=“xsd:int”>2159</width_tmm>

<length_tmm

xmlns:ns0=“http://www.w3.org/1999/XMLSchema”
xsi:type=“xsd:int”>2794</length_tmm>

<width_pt

xmlns:ns0=“http://www.w3.org/1999/XMLSchema”
xsi:type=“xsd:int”>612</width_pt>

<length_pt

xmlns:ns0=“http://www.w3.org/1999/XMLSchema”
xsi:type=“xsd:int”>792</length_pt>

<width_mils

xmlns:ns0=“http://www.w3.org/1999/XMLSchema”
xsi:type=“xsd:int”>8500</width_mils>

<length_mils

xmlns:ns0=“http://www.w3.org/1999/XMLSchema”
xsi:type=“xsd:int”>11000</length_mils>

<userUnit

xmlns:ns0=“http://www.w3.org/1999/XMLSchema”
xsi:type=“xsd:int”>4</userUnit>

<displayString

xmlns:ns0“http://www.w3.org/1999/XMLSchema”
xsi:type=“xsd:string”>8.5 × 11</displayString>

<isObsolete

xmlns:ns0=“http://www.w3.org/1999/XMLSchema”
xsi:type=“xsd:boolean”>false</isObsolete>

</id6>

<!-- More Items here -->

</soap:Body>
</soap:Envelope>

Each of the five attributes is associated with an identification number. For each attribute, the SOAP message provides five fields that return the value of the attribute to the remote processing system 20. The five fields include: “ID”, “StringID”, “DisplayString”, “isWildCard”, and “isObsolete”. In this manner, the printing system 26 may return the attributes to the remote processing system 20 for display by the printer driver or other application employing a rule-based protocol communication with the printing system 26.

The foregoing detailed description is merely illustrative of several physical embodiments of the invention. Physical variations of the invention, not fully described in the specification, may be encompassed within the purview of the claims. In addition, the steps of the flow diagrams may be taken in sequences other than those described, and more or fewer elements or component may be used in the block diagrams. Accordingly, any narrower description of the elements in the specification should be used for general guidance, rather than to unduly restrict any broader descriptions of the elements in the following claims.

The following is claimed:

1. A method of communicating with a printing system over a communications network using a rule-based protocol comprising:
building a rule-based protocol request message on a remote processing system, wherein the rule-based protocol request message includes an operator name;
transmitting the rule-based protocol request message from the remote processing system to the printing system over the communications network;
determining whether the remote processing system receives a rule-based protocol response message from the printing system; and
when the remote processing system receives the rule-based protocol response message from the printing system, reading an attribute name associated with the operator name, wherein the rule-based protocol response message includes the attribute name.

2. A computer readable medium, having stored therein instructions for causing a central processing unit to execute the method of claim 1.

3. The method of claim 1 wherein the building and reading steps are performed by a printer driver running on the remote processing system.

4. The method of claim 1 wherein the rule-based protocol request message is a Simple Object Access Protocol request message.

5. The method of claim 1 wherein the rule-based protocol response message is a Simple Object Access Protocol response message.
